(19) United States
(12) Patent Application Publication
(10) Pub. No.: US 2014/0038001 A1
(43) Pub. Date: Feb. 6, 2014

(54) POWER BATTERY SAFETY COVER

(71) Applicant: NingDe Contemporary Amperex Technology Limited, Ningde City (CN)

(72) Inventors: Rulai Cai, Ningde City (CN); Pinghua Deng, Ningde City (CN); Peng Wang, Ningde City (CN); Quankun Li, Ningde City (CN); Kai Wu, Ningde City (CN)

(73) Assignee: NingDe Contemporary Amperex Technology Limited, Ningde City (CN)

(21) Appl. No.: 13/953,850

(22) Filed: Jul. 30, 2013

(30) Foreign Application Priority Data
Aug. 2, 2012 (CN) 201220379790.5

(51) Int. Cl. H01M 2/04

(52) U.S. Cl. CPC H01M 2/043
USPC 429/53

(57) ABSTRACT

The invention pertains to the technical field of a power battery, in particular to a power battery safety cover, comprising a cover plate, and a first terminal, a second terminal, a pressure release valve, a filling hole and a safety turning valve which are arranged on the cover plate, wherein the safety turning valve is electrically connected to the cover plate, on the cover plate is provided with a conducting plate for short-circuit protection which is electrically connected to the second terminal; the conducting plate for short-circuit protection, positioned above the safety turning valve, comprises a conducting plate main body and a first groove arranged on the conducting plate main body, and thickness of bottom of the first groove is less than that of the safety turning valve.

### FIELD OF THE INVENTION

The invention pertains to the technical field of a power battery, in particular to a power battery cover with a safety protection function.

### BACKGROUND OF THE INVENTION

With development of modern society and strengthening of environmental protection consciousness, more and more devices can be equipped with selectable and rechargeable secondary batteries as a power supply, such as mobile phones, notebook computers, power tools, electric automobiles and so on, which provides broad space for application and development of rechargeable secondary batteries.

Electric automobiles and storage power stations generally need power batteries of large capacity as their power supplies. These power batteries are characterized by high power capacity, good safety and longer cycle life etc., so as to meet usage criteria and users' demands.

Generally, a pressure release valve is installed on the power battery cover in order to guarantee safety thereof to some extent. Once an accident occurs in a battery when it is subject to improper battery charging, short circuit or exposure to high temperature and other severe environment, the high energy battery may produce a large amount of gas, with the temperature rising sharply; the gas bursts through the pressure release valve, thus the purpose of pressure release is reached. The pressure release valve can improve safety performance of the battery to a certain extent. However, a malfunctioning battery itself constitutes a hidden danger because of failure of release of energy accumulated; furthermore, overcharge of a malfunctioning battery may result in larger security accidents.

In the prior art, a safety turning valve is installed on a power battery cover, which can improve safety performance of the power battery to some extent. However in actual use, the safety turning valve may be melted through by overcurrent generated by short circuit of the battery, thus resulting in battery leakage, outbreak of a fire or even a burst etc. consequently, the safety performance is not satisfactory.

On that account, it is indeed necessary to provide a power battery cover with safety protection function which comprises a structure capable of protecting the safety turning valve, preventing a malfunctioning battery from overcharge and releasing internal energy of the malfunctioning battery, thus further improving safety performance of the power battery.

### SUMMARY OF THE INVENTION

The aim of the invention is, in view of disadvantages of the prior art, to provide a power battery cover with safety protection function which comprises a structure capable of protecting the safety turning valve, preventing a malfunctioning battery from overcharge and releasing internal energy of the malfunctioning battery, thus further improving safety performance of the power battery so as to overcome disadvantages of the power battery cover in the prior art.

In order to achieve the above-mentioned aim, the invention adopts such a technical scheme as below:

A power battery safety cover comprises a cover plate, and a first terminal, a second terminal, a pressure release valve, a filling hole and a safety turning valve which are arranged on the cover plate, wherein the first terminal is electrically connected to the cover plate, the second terminal is subject to an insulated assembly with the cover plate, the safety turning valve is electrically connected to the cover plate, on the cover plate is provided with a conducting plate for short-circuit protection which is electrically connected to the second terminal; the conducting plate for short-circuit protection, positioned above the safety turning valve, comprises a conducting plate main body and a first groove arranged on the conducting plate main body, and thickness of bottom of the first groove is less than that of the safety turning valve.

As an improvement of the power battery safety cover in the invention, the first groove is positioned above the safety turning valve.

As an improvement of the power battery safety cover in the invention, thickness of bottom of the first groove is 20-90% of that of the safety turning valve.

As an improvement of the power battery safety cover in the invention, the cross section of the first groove is shaped like a circle, an oval or a rectangle.

As an improvement of the power battery safety cover in the invention, one end of the conducting plate for short-circuit protection is welded, riveted, bolt connected or cohered to the cover plate, while other end of the conducting plate for short-circuit protection is welded, riveted, bolt connected or cohered to the second terminal.

As an improvement of the power battery safety cover in the invention, the safety turning valve is welded to the cover plate.

As an improvement of the power battery safety cover in the invention, the safety turning valve is provided a second groove.

As an improvement of the power battery safety cover in the invention, bottom of the first groove is provided with a hole.

As an improvement of the power battery safety cover in the invention, the area of the hole accounts for 5-20% of the total area of the bottom of the first groove.

As an improvement of the power battery safety cover in the invention, bottom of the first groove is provided with a fuse link.

Compared with the prior art, in the invention, on the cover plate is provided with the safety turning valve on which the conducting plate for short-circuit protection is arranged. The safety turning valve turns and achieves an external short circuit with the conducting plate for short-circuit protection when the battery breaks down thus resulting in air pressure rising to a preset pressure for the safety turning valve. The first groove arranged on the conducting plate for short-circuit protection has a low thickness, which becomes a vulnerable point, capable of fusing and absorption of heat ahead of the safety turning valve; after the first groove is fused, resistance between the safety turning valve and the conducting plate for short-circuit protection is reduced, thus protecting the safety turning valve from melting through and playing a role of safety protection. Consequently, the power battery safety cover of the invention can also, on the one hand, prevent the battery from potential safety hazards resulted from overcharge in case of malfunction of the battery, and on the other hand, release battery energy by the external short circuit, thus avoiding larger accidents.

### BRIEF DESCRIPTION OF THE DRAWINGS

FIG. 1 is a section view of the invention;

FIG. 2 is an enlarged view of A in FIG. 1;

FIG. 3 is a schematic view of the safety turning valve of the invention; and

FIG. 4 is a schematic view of the conducting plate for short-circuit protection of the invention.

### DETAILED DESCRIPTION OF THE EMBODIMENTS

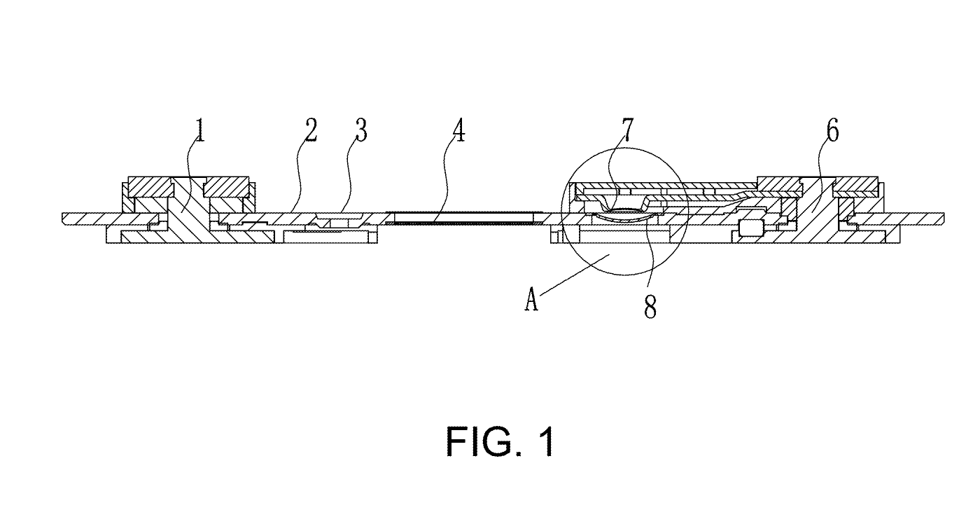

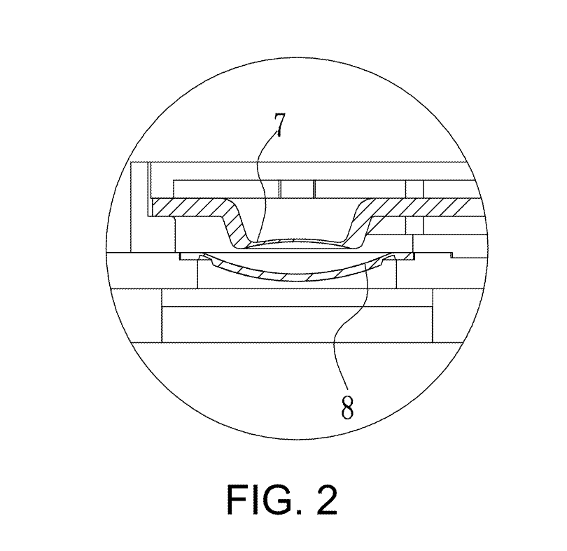

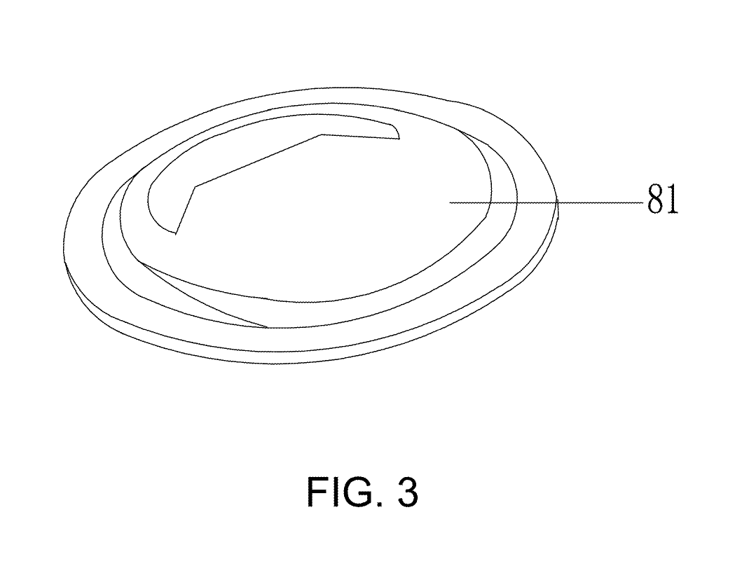

Just as shown in FIGS. 1-4, the invention provides a power battery safety cover, comprising a cover plate 2, and a first terminal 1, a second terminal 6, a pressure release valve 4, a filling hole 3 and a safety turning valve 8 which are arranged on the cover plate 2, wherein the first terminal 1 is electrically connected to the cover plate 2, the second terminal 6 is subject to an insulated assembly with the cover plate 2, the safety turning valve 8 is electrically connected to the cover plate 2, on the cover plate 2 is provided with a conducting plate for short-circuit protection 7 which is electrically connected to the second terminal 6; the conducting plate for short-circuit protection 7, positioned above the safety turning valve 8, comprises a conducting plate main body 71 and a first groove 72 arranged on the conducting plate main body, and thickness of bottom of the first groove 72 is less than that of the safety turning valve 8. So, bottom of the first groove 72 a vulnerable point of the conducting plate for short-circuit protection 7, guaranteeing the conducting plate for short-circuit protection 7 is melted through ahead of the safety turning valve 8, thus making the safety turning valve 8 be subject to protection of the conducting plate for short-circuit protection 7, not to be damaged before the conducting plate for short-circuit protection 7 is fused. Arrangement of the first groove 72 can be realized by the way of a convex-concave extension hole, reduction of thickness of a flat plate or reduction of material of a punched hole etc; furthermore, the conducting plate for short-circuit protection 7 had better use material of lower fusing point, such as tin or aluminum. While the safety turning valve 8 had better use material of higher fusing point, such as copper or iron etc. The safety turning valve 8 shall be lower than the conducting plate for short-circuit protection 7 in terms of heating value and temperature rise, and higher than the conducting plate for short-circuit protection 7 in terms of heat dissipation. Thereinto, the first terminal 1 is welded, riveted or electrically connected to the cover plate 2, while the second terminal 6 is assembled on the cover plate 2 by means of injection moulding insulation. The safety turning valve 8 has a turning air pressure of 0.3-0.5 MPa, free from rupture under an air pressure of 0.7 MPa, and has a turning height of not less than 0.5 mm.

Thereinto, the first groove 72 is positioned above the safety turning valve 8; and the safety turning valve 8 is apt to touch the first groove 72 in case of a battery failure.

Thickness of bottom of the first groove 72 is 20-90% of that of the conducting plate main body 71. Too low thickness of the first groove 72 is to the disadvantage of manufacturing of the conducting plate for short-circuit protection 7; however, if thickness of the first groove 72 is too high, it is not easily to be melted in advance, unable to play a role of protecting the safety turning valve 8.

The cross section of the first groove 72 is shaped like a circle, an oval or a rectangle.

One end of the conducting plate for short-circuit protection 7 is welded, riveted, bolt connected or cohered to the cover plate 2, while the other end of the conducting plate for short-circuit protection 7 is welded, riveted, bolt connected or cohered to the second terminal 6, in this way, the conducting plate for short-circuit protection 7 can be electrically connected to both the cover plate 2 and the second terminal 6 simultaneously.

The safety turning valve 8 is welded to the cover plate 2, particularly, the safety turning valve 8 can be hermetically connected to a hole arranged on the cover plate 2 by way of laser welding.

The safety turning valve 8 is provided with a second groove 81. In order to make the safety turning valve 8 easily be turned, wall thickness of the second groove 81 shall be nonuniform.

A surface treatment layer is arranged on the surface of the safety turning valve 8 so as to improve the galvanization capability of the safety turning valve 8, to make the safety turning valve 8 be lower than the conducting plate for short-circuit protection 7 in terms of heating value and temperature rise, and higher than the conducting plate for short-circuit protection 7 in terms of heat dissipation. The surface treatment can be sputtering or electroplating. Material of the surface treatment layer can be brass, bronze or nickel etc.

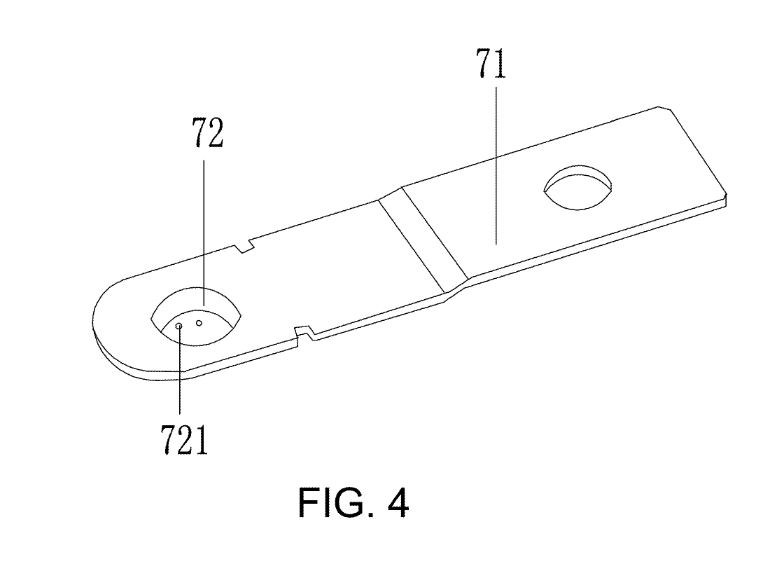

Bottom of the first groove 72 is provided with a hole 721 (just as shown in FIG. 4), thus making a vulnerable point on the bottom of the first groove 72, so as to improve the sensitivity and realize advance melt and heat absorption of a fixed point; and both resistance and heating value between the conducting plate for short-circuit protection 7 and the safety turning valve 8 are reduced, thus protecting the safety turning valve 8 from melting through and playing a role of protecting the safety turning valve 8.

The hole 721 can be either a through hole or a blind hole.

Area of the hole 721 accounts for 5-20% of the total area of the bottom of the first groove 72.

Bottom of the first groove 72 can also be provided with a fuse link which is made into a sheet metal by using magnesium aluminum alloy. The sheet metal, shaped like a concave, a convex or a T, can be rapidly melted through in advance when short-circuit current of the battery exceeds a preset value, thus protecting the safety turning valve 8.

Under normal circumstance, the safety turning valve 8 does not touch the conducting plate for short-circuit protection 7; the air pressure in the battery rises in case of a battery failure; when the internal air pressure reaches the turning pressure of the safety turning valve 8, the safety turning valve 8 turns and touches the conducting plate for short-circuit protection 7, thus realizing an external short circuit of the battery. The first groove 72 of the conducting plate for short-circuit protection 7 absorbs heat and is fused in advance, and both resistance and heating value between the conducting plate for short-circuit protection 7 and the safety turning valve 8 are reduced, thus protecting the safety turning valve 8 from melting through and playing a role of protecting the safety turning valve 8. In this way, overcharge can be digested on the one hand, and on the other hand the battery energy can be released, thus eliminating potential safety hazards.

Those skilled in the art can, on the basis of disclosure and instruction of the specification above-mentioned, make a change or modification of the embodiments mentioned above. Therefore, the invention is not limited to the embodiments, and equivalent modification and change of the invention are within the scope of protection of claims of the invention. In addition, some specific terms are used in the specification for the convenience of description, but not to limit the invention.

What is claimed is:

1. A power battery safety cover comprising a cover plate (2), and a first terminal (1), a second terminal (6), a pressure release valve (4), a filling hole (3) and a safety turning valve (8) which are arranged on the cover plate (2), wherein the first terminal (1) is electrically connected to the cover plate (2), the second terminal (6) is subject to an insulated assembly with the cover plate (2), the safety turning valve (8) is electrically connected to the cover plate (2), on the cover plate (2) is provided with a conducting plate for short-circuit protection (7) which is electrically connected to the second terminal (6); the conducting plate for short-circuit protection (7), positioned above the safety turning valve (8), comprises a conducting plate main body (71) and a first groove (72) arranged on the conducting plate main body, and thickness of bottom of the first groove (72) is less than that of the safety turning valve (8).

2. The power battery safety cover of claim 1, wherein the first groove (72) is positioned above the safety turning valve (8).

3. The power battery safety cover of claim 1, wherein thickness of bottom of the first groove (72) is 20-90% of that of the safety turning valve (8).

4. The power battery safety cover of claim 3, wherein the cross section of the first groove (72) is shaped like a circle, an oval or a rectangle.

5. The power battery safety cover of claim 1, wherein one end of the conducting plate for short-circuit protection (7) is welded, riveted, bolt connected or cohered to the cover plate (2), while the other end of the conducting plate for short-circuit protection (7) is welded, riveted, bolt connected or cohered to the second terminal (6).

6. The power battery safety cover of claim 1, wherein the safety turning valve (8) is welded to the cover plate (2).

7. The power battery safety cover of claim 6, wherein the safety turning valve (8) is provided a second groove (81).

8. The power battery safety cover of claim 1, wherein bottom of the first groove (72) is provided with a hole (721).

9. The power battery safety cover of claim 8, wherein the area of the hole (721) accounts for 5-20% of the total area of the bottom of the first groove (72).

10. The power battery safety cover of claim 1, wherein bottom of the first groove (72) is provided with a fuse link.
